(19) United States
(12) Patent Application Publication
(10) Pub. No.: US 2009/0297893 A1
(43) Pub. Date: Dec. 3, 2009

(54) MOBILE APPARATUS AND MOBILE PHONE

(75) Inventor: Koichi ITO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/361,726

(22) Filed: Jan. 29, 2009

(30) Foreign Application Priority Data
May 28, 2008 (JP) P2008-139497

(51) Int. Cl. H01M 12/02; H01M 12/08

(52) U.S. Cl. 429/9

(57) ABSTRACT

According to one aspect of the invention, there is provided a mobile apparatus including: a rechargeable battery; a fuel cell configured to charge the rechargeable battery; a first determining module configured to determine whether the fuel cell is generating power; a second determining module configured to determine whether a power generation condition of the fuel cell is satisfied when the first determining module determines that the fuel cell is not generating power; and a notifying module configured to notify a user that the fuel cell is not generating power when the second determining module determines that the power generation condition is satisfied.

The entire disclosure of Japanese Patent Application No. 2008-139497 filed on May 28, 2008, including specification, claims, drawings and abstract is incorporated herein by reference in its entirety.

### BACKGROUND

1. Field of the Invention

One aspect of the present invention relates to a mobile apparatus equipped with a rechargeable battery and a fuel cell configured to charge the rechargeable battery.

2. Description of the Related Art

In recent years, with increase in miniaturization and functionalization of electronic apparatuses as typified by mobile phones and cameras, further increase in miniaturization and functionalization has come to be required in batteries as power sources of electronic apparatuses. Small fuel cells that are higher in energy density than lithium-ion batteries are now attracting attention as batteries capable of satisfying such requirements, and electronic apparatuses having a fuel cell as a power source are being commercialized.

For example, JP-A-2005-17327 discloses an electronic apparatus in which oxygen that is necessary for power generation of a fuel cell can be reliably supplied to the fuel cell. In this electronic apparatus, an air opening for allowing the internal space of a battery room to communicate with outside of a body is formed at a position that is close to the center of a front face of the body and that is not located in a portion to be held by the user. And a projection/recess portion is formed as an air opening guard on the opposite side of the air opening to the side where a lens barrel is disposed.

In mobile apparatuses such as cameras having a fuel cell, a method of providing the projection/recess portion as the air opening guard or a like can prevent the air opening from being covered by a finger when the user holds the mobile apparatus. Furthermore, it is desirable that such mobile apparatuses are equipped with a rechargeable battery that is charged by the fuel cell and are able to charge the rechargeable battery efficiently by monitoring the power generation status of the fuel cell and thereby giving proper information to the user.

### SUMMARY

According one aspect of the invention, there is provided a mobile apparatus including: a rechargeable battery; a fuel cell configured to charge the rechargeable battery; a first determining module configured to determine whether the fuel cell is generating power; a second determining module configured to determine whether a power generation condition of the fuel cell is satisfied when the first determining module determines that the fuel cell is not generating power; and a notifying module configured to notify a user that the fuel cell is not generating power when the second determining module determines that the power generation condition is satisfied.

### BRIEF DESCRIPTION OF THE DRAWINGS

Embodiment may be described in detail with reference to the accompanying drawings, in which:

FIG. 1A is an exemplary front view of a cell phone according to a first embodiment in an open state;

FIG. 1B is an exemplary side view of the mobile phone in the open state;

FIG. 2A is an exemplary rear view of the mobile phone according to the first embodiment in a closed state;

FIG. 2B is an exemplary side view of the mobile phone in the closed state;

FIG. 3 is an exemplary functional block diagram of the mobile phone according to the first embodiment;

FIG. 4 is an exemplary graph showing an electric discharge curve of a rechargeable battery of the mobile phone according to the first embodiment;

FIG. 5 is an exemplary functional block diagram of a power circuit module of the mobile phone according to the first embodiment;

FIG. 6 is an exemplary flowchart showing a procedure of an alarm process of the mobile phone according to the first embodiment;

FIGS. 7A to 7D show exemplary alarm pictures of the mobile phone according to the first embodiment;

FIG. 8 is an exemplary flowchart showing a procedure of another alarm process of the mobile phone according to the first embodiment;

FIGS. 9A and 9B are exemplary displayed pictures showing power generation statuses of the mobile phone according to the first embodiment; and

FIG. 10 is an exemplary flowchart showing a procedure of an alarm process of a mobile phone according to a second embodiment.

### DETAILED DESCRIPTION OF THE EMBODIMENTS

### First Embodiment

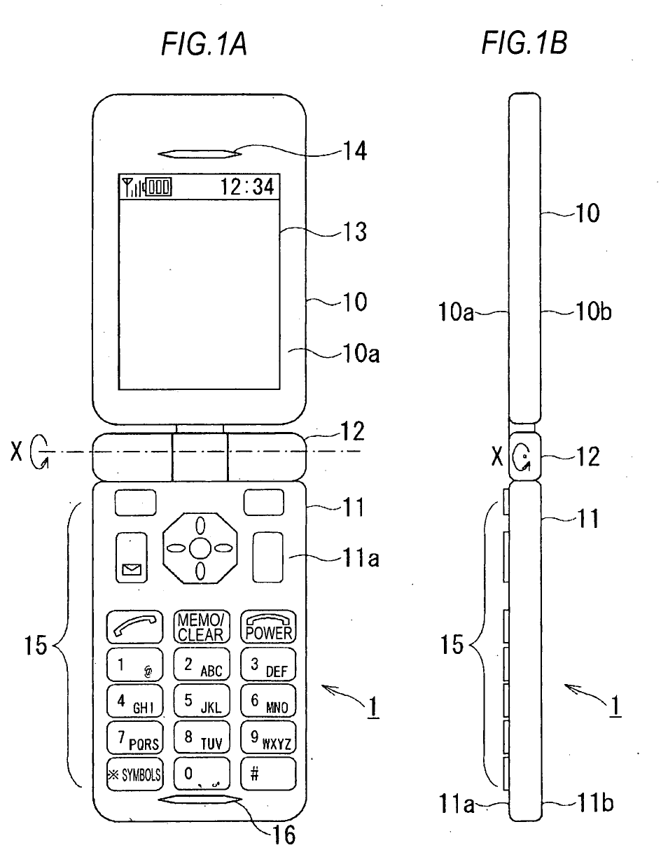

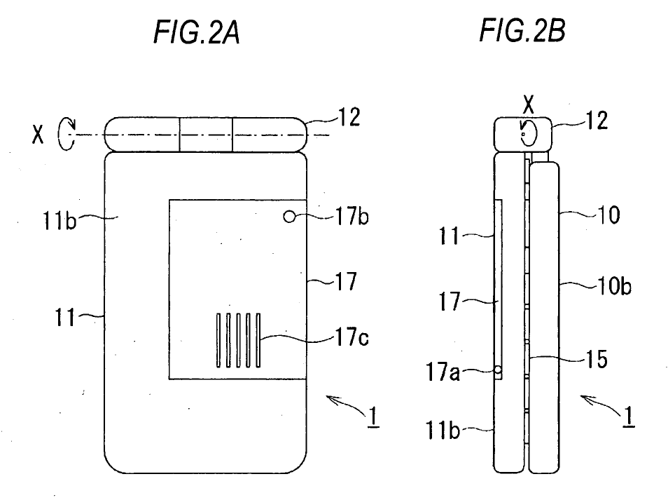

A mobile apparatus according to a first embodiment of the present invention will be described below with reference to FIGS. 1 to 7. A clamshell-type mobile phone 1 in which two bodies are swingably connected to each other in will be described as an example mobile apparatus according to the first embodiment. FIG. 1A is a front view of the mobile phone 1 in an open state, and FIG. 1B is a side view of the mobile phone 1 in the open state. FIG. 2A is a rear view of the mobile phone 1 in a closed state, and FIG. 2B is a side view of the mobile phone 1 in the closed state.

As shown in FIGS. 1 and 2, the mobile phone 1 is mainly configured of a rectangular-plate-like top body 10 and a bottom body 11 having approximately the same shape as the top body 10. In a closed state, the top body 10 and the bottom body 11 are stacked with faces of each body covered each other. The top body 10 and the bottom body 11 are hinge-connected to each other with a hinge portion 12 interposed in between so that the top body 10 can be rotated about the hinge portion 12 (serving as an axis) with respect to the bottom body 11 by an angle in a direction indicated by X in FIGS. 1 and 2. The mobile phone 1 is deformed between a closed state and an open state by rotating the top body 10 with respect to the bottom body 11.

An inside face 10a (i.e., the face to confront the bottom body 11) of the top body 10 is provided with a display 13 for displaying information including a text, an image, etc. and a speaker 14 for outputting a voice received from a counterpart during a call. In a state that the mobile phone 1 is closed, the display 13 and the speaker 14 are not exposed and covered with the bottom body 11. On the other hand, they are exposed in a state that the mobile phone 1 is opened by rotating the top body 10 with respect to the bottom body 11.

For example, an inside face 11a (i.e., a face confronting the top body 10) of the bottom body 11 is provided with manipulation keys 15 including a power key for switching on/off the power, a call key for starting call origination processing, a ten-key unit for input of a number or characters, and shortcut keys for activating a mail function or a Web-browsing function. The inside face 11a of the bottom body 11 is also provided with a microphone 16 for picking up a voice. In a state that the mobile phone 1 is closed, the manipulation keys 15 and the microphone 16 are not exposed and covered with the top body 10. On the other hand, they are exposed in a state that the mobile phone 1 has been opened by rotating the top body 10 with respect to the bottom body 11.

An outside face 11b (i.e., a face that not confronting the top body 10) of the bottom body 11 is provided with a battery unit 17 for supplying power to the mobile phone 1. The battery unit 17 is equipped with a rechargeable battery 30 (described later) inside and is stored with fuel to be used for charging the rechargeable battery 30. The battery unit 17 is formed with a fuel injection opening 17a through which to inject fuel, an air opening 17b through which to take oxygen that is necessary for power generation from outside, and an outlet 17c through which to discharge moisture etc. that are generated through power generation. The fuel injection opening 17a, the air opening 17b, and the outlet 17c of the fuel unit 17 are exposed in both of a state that the mobile phone 1 is closed and a state that it is opened. As a result, in the mobile phone 1, a fuel cell can generate power and thereby charge the rechargeable battery 30 irrespective of whether the mobile phone 1 is closed or opened.

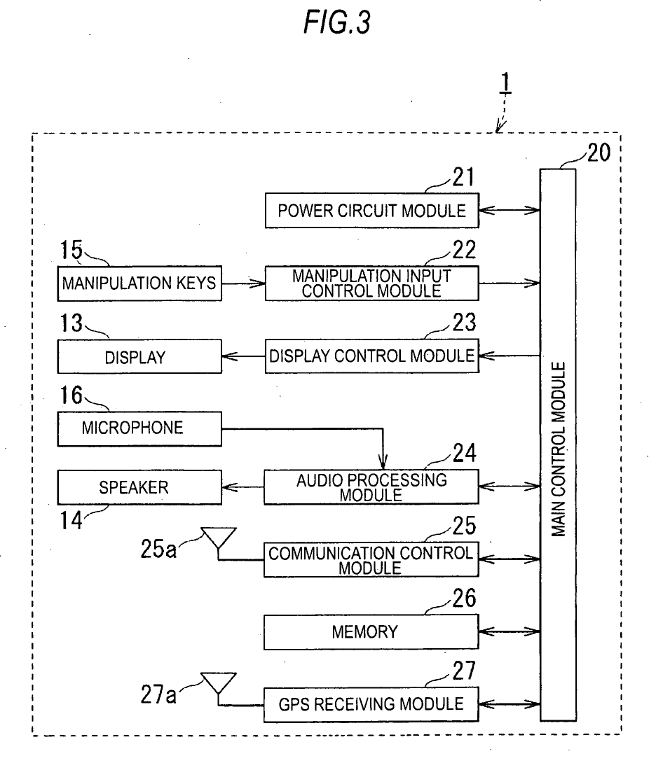

Next, the functions of the mobile phone 1 will be described with reference to a functional block diagram of FIG. 3. As shown in FIG. 3, the mobile phone 1 includes a main control module 20, a power circuit module 21, a manipulation input control module 22, a display control module 23, an audio processing module 24, a communication control module 25, a memory 26, and a GPS receiving module 27. They are connected to each other via a bus so as to be able to communicate with each other.

Having a central processing unit (CPU), the main control module 20 performs a general control as well as various kinds of computation processing, control processing, etc. Having the rechargeable battery 30 (described later; e.g., a lithium-ion battery), the power circuit module 21 switches on or off the power of the mobile phone 1 in response to, for example, an input through the corresponding manipulation key 15. While the power is on, the power circuit module 21 supplies power to the individual modules from the rechargeable battery 30 and thereby renders the mobile phone 1 operational. Also having the fuel cell, the power circuit module 21 generates power using the fuel cell to charge the rechargeable battery 30 according to the voltage of the rechargeable battery 30. Furthermore, the power circuit module 21 performs alarm processing for the user according to the voltage of the rechargeable battery 30 and the power generation status of the fuel cell. The details of the power circuit module 21 will be described later.

The manipulation input control module 22 has an input interface for the manipulation keys 15. Upon detecting that one of the manipulation keys 15 is pressed, the manipulation input control module 22 generates a signal indicating the pressed key 15 and sends it to the main control module 20. Having a display interface for the display 13, the display control module 22 displays information including a text, an image, etc. on the display 13 under the control of the main control module 20.

The audio processing module 24 generates, under the control of the main control module 20, an analog audio signal from a voice that is picked up through the microphone 16, converts the analog audio signal into a digital audio signal, and sends the latter to the main control module 20. Furthermore, when acquiring a digital audio signal, the audio processing module 24 converts it into an analog audio signal and controls the speaker 14 to output the latter as a voice.

Having an antenna 25a for transmitting or receiving a signal to or from a base station (not shown), the communication control module 25 receives a reception signal from a base station and recovers data by performing spectrum inverse spreading processing or the reception signal under the control of the main control module 20. Under the control of the main control module 20, the recovered data is sent to the audio processing module 24 and output from the speaker 14, sent to the display control module 22 and displayed on the display 13, or stored in the memory 26.

Under the control of the main control module 20, the communication control module 25 acquires an audio signal that is input through the microphone 16, data that is input through the manipulation keys 15, or data that is stored in the memory 26, performs spectrum spreading processing on the acquired data, and transmits resulting data to a base station via the antenna 25a.

The memory 26 includes a read-only memory (ROM), a hard disk, and a nonvolatile memory for storing programs of various processes to be performed by the main control module 20, data necessary for those processes, and other information, a random access memory (RAM) for temporarily storing data to be used when the main control module 20 performs those processes. It is assumed that a program to be run when the power circuit module 21 performs an alarm process (described later) is stored in the ROM, for example.

Having an antenna 27a for receiving GPS information that is broadcast from a GPS broadcasting station (not shown), the GPS receiving module 27 generates information indicating a current position of the mobile phone 1 based on GPS information received via the antenna 27a and sends it to the main control module 20 and the power circuit module 21.

The mobile phone 1 is supplied with power from the rechargeable battery 30 not only in a communication state but also in a standby state. More specifically, the communication control module 25 is supplied with a peak current of several hundred milliamperes in a communication state and is supplied with an average current of several milliamperes in a standby state because it receives and monitors radio waves that are transmitted from a base station intermittently. Furthermore, when the display control module 23 displays, on the display 13, an image stored in the memory 26, an image that is sent from another mobile phone over a mobile phone network, or some other images, which are supplied with much power from the rechargeable battery 30.

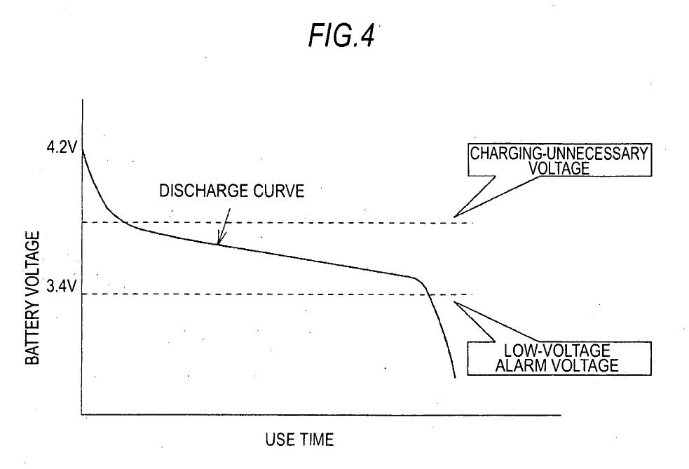

FIG. 4 is a graph showing an electric discharge curve of the rechargeable battery 30 of the mobile phone 1. In this graph, the vertical axis represents voltage of the rechargeable battery 30 and the horizontal axis represents use time. This graph shows that when the mobile phone 1 is used after the rechargeable battery 30 has been charged up, the voltage of the rechargeable battery 30 drops steeply in the beginning, a stable voltage state is thereafter maintained for a time, and then the voltage drops steeply again.

The power circuit module 21 starts to generate power using fuel and thereby charge the rechargeable battery 30 upon detecting a fact that the voltage of the rechargeable battery 30, which decreases as the mobile phone 1 consumes power, has become lower than a first threshold value (a charging-unnecessary voltage shown in FIG. 4). Furthermore, upon detecting a fact that the voltage of the rechargeable battery 30 has become lower than a second threshold value (a low-voltage alarm voltage shown in FIG. 4), the power circuit module 21 controls the display 13 to display a message that the battery voltage is too low, and controls the speaker 14 to output an alarm sound indicating that the battery voltage is too low. Based on this display or the alarm sound, the user connects the mobile phone 1 to an AC adapter and thereby charges the rechargeable battery 30.

A commercial power source (e.g., AC 100 V) is necessary for charging of a mobile phone via an AC adapter. However, while the user is in a long-time movement, he or she cannot connect the mobile phone to the commercial power source, which is inconvenient. One countermeasure against this problem is to use a fuel cell as a power source. However, whereas fuel cells can provide a large battery capacity, it is difficult for them to supply a large current of several hundred milliamperes which is necessary at the time of a communication etc. In view of this, the mobile phone 1 according to the embodiment employs, in combination, the fuel cell and the main battery (rechargeable battery 30) which enables a communication.

Unlike in such electronic apparatuses as cameras in which the supply of power is required only during use, the mobile phone 1 constantly needs the supply of power because it is rendered in a standby state while it is in a power-on state but is not being used by the user though. In apparatuses which consume power constantly, it is preferable that power generation (charging) be performed constantly. However, the mobile phone 1 is frequently carried by the user in moving. Therefore, it is highly probable that the mobile phone 1 is put in a pocket or a bag for a long time. In such a situation, one or both of the air opening 17b and the outlet 17c which are necessary for power generation may be covered contrary to the user's intention, whereby the mobile phone 1 is disabled from power generation.

In view of the above, the power circuit module 21 of the mobile phone 1 constantly monitors the voltage of the rechargeable battery 30 and the power generation status of the fuel cell. When power is not being generated though the voltage of the rechargeable battery 30 is low, the power circuit module 21 specifies the cause and performs alarm processing of raising an alarm to the user.

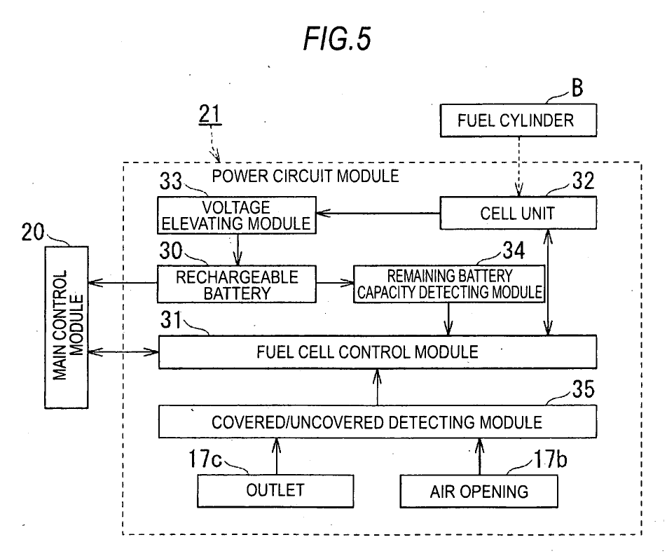

FIG. 5 is a functional block diagram of the power circuit module 21. As shown in FIG. 5, the power circuit module 21 is equipped with the rechargeable battery 30. Being a lithium-ion battery, for example, the rechargeable battery 30 can store externally supplied electric power.

The power circuit module 21 is also equipped with a fuel cell control module 31 for controlling and monitoring the power generation and voltage elevation by the fuel cell. The fuel cell control module 31 performs a control of charging the rechargeable battery 30 by supplying it with power generated by the fuel cell by using fuel that was supplied from an external fuel cylinder B. The fuel cell control module 31 is further equipped with a cell unit 32 as the fuel cell for generating power (e.g., 0.5 W) using fuel that was supplied from the fuel cylinder B and a voltage elevating module 33 for elevating the output voltage of the cell unit 32 (which varies depending on the load) and supplies a resulting voltage (e.g., 4.3 V) to the rechargeable battery 30.

The power circuit module 21 is also equipped with a remaining battery capacity detecting module 34 for detecting the voltage of the rechargeable battery 30 to start charging of the rechargeable battery 30 when its voltage has become low. Furthermore, since the cell unit 32 cannot generate power if the air opening 17b or the outlet 17c is covered by some object, the power circuit module 21 is equipped with a covered/uncovered detecting module 35 for detecting whether the air opening 17b and the outlet 17c are uncovered.

The fuel cell control module 31 acquires information indicating a remaining fuel amount. For example, the mobile phone 1 is equipped with a device for measuring a weight of the fuel stored in the mobile phone 1. The fuel cell control module 31 acquires a fuel weight from this device and calculates a remaining fuel amount from the fuel weight. The fuel cell control module 31 also acquires information indicating a covered/uncovered status of the air opening 17b and the outlet 17c by, for example, detecting a flow rate or detecting a reflection quantity of light that is emitted intermittently from an LED or the like from inside the opening. For example, the fuel cell control module 31 determines that the air opening 17b or the outlet 17c is covered when the reflection quantity is larger than a threshold value.

If the remaining battery capacity detecting module 34 detects that the voltage of the rechargeable battery 30 is lower than the first threshold value (the charging-unnecessary voltage shown in FIG. 4), the fuel cell control module 31 checks whether power generation is being performed (by, for example, detecting the output voltage of the cell unit 32 or heat generation). If power is not being generated and sufficient fuel does not remain, the fuel cell control module 31, for example, controls the speaker 14 to output an alarm sound and thereby urges the user to replenish fuel. Likewise, the fuel cell control module 31 alarms the user to urge him or her to uncover the air opening 17b if it is covered, and alarms the user to urge him or her to uncover the outlet 17c if it is covered. When sufficient fuel exists and both the air opening 17b and the outlet 17c are uncovered, an operation failure may have occurred in cell unit 32. Therefore, in this situation, the fuel cell control module 31 controls the display 13 to display a message to that effect. When an alarm sound is to be generated, it is appropriate to generate an alarm sound regularly by using a timer.

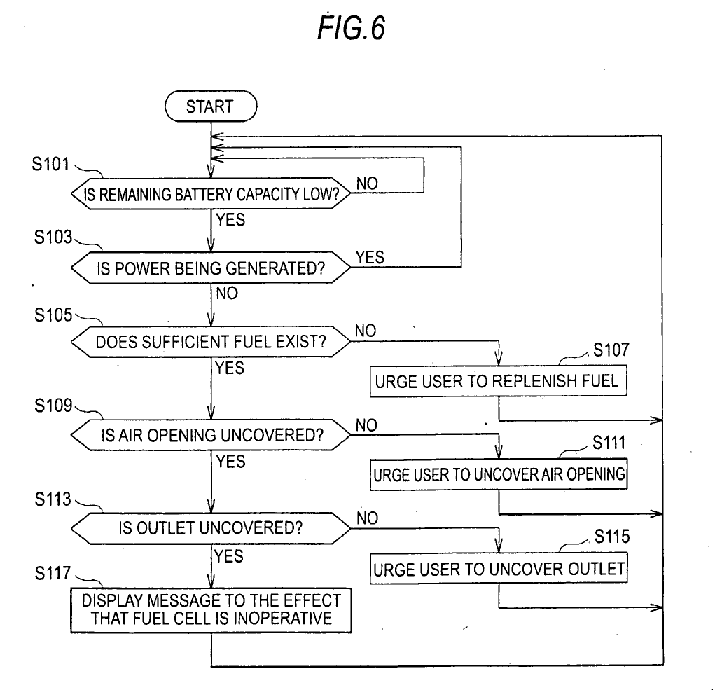

The procedure of the above alarm process of the mobile phone 1 will be described below with reference to a flowchart of FIG. 6. The mobile phone 1 performs the alarm process while it is activated irrespective of whether it is being used by the user for a communication or it is in a standby state.

First, at step S101, the fuel cell control module 31 determines whether the remaining capacity (voltage) of the rechargeable battery 30 is low. More specifically, the fuel cell control module 31 calculates a voltage of the rechargeable battery 30 and determines that the remaining battery capacity is low when the calculated battery voltage is lower than the first threshold value (the charging-unnecessary voltage shown in FIG. 4) (S101: yes). If the remaining battery capacity is not low (S101: no), the fuel cell control module 31 stands by because it is not necessary to generate power.

If the remaining battery capacity is low (S101: yes), at step S103 the fuel cell control module 31 determines whether power generation is being performed by the cell unit 32 by using fuel. More specifically, the fuel cell control module 31 checks whether power generation is being performed by, for example, detecting an output voltage of the cell unit 32 or heat generation. If power generation is being performed (S103: yes), the process returns to step S101 to cause the fuel cell control module 31 to again determine whether the remaining battery capacity is low because it is not necessary to alarm the user.

When the remaining battery capacity is low and power generation is not being performed (S103: no), power generation should be being performed. In this case, at first, the fuel cell control module 31 determines at step S105 whether sufficient fuel exists to identify the reason why power generation is not being performed. The fuel cell control module 31 makes this determination by calculating a remaining fuel amount based on a fuel weight or else.

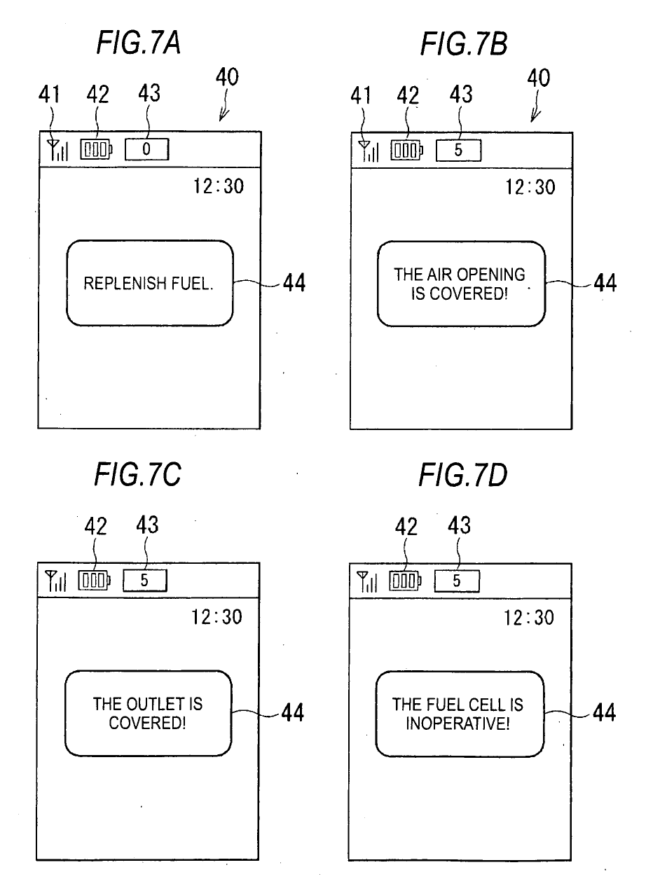

When sufficient fuel does not exist (S105: no), the main control module 20 urges the user to replenish fuel at step S107. A preferable way to do this is to display on a display screen 40 of the display 13, a display section 44 containing a sentence for urging the user to replenish fuel such as “Replenish fuel” (see FIG. 7A).

A fuel icon 43 indicating a remaining fuel amount is displayed on the display screen 40 together with an electric field icon 41 indicating a radio wave status and a battery icon 44 indicating a remaining capacity of the rechargeable battery 30. For example, the fuel icon 43 indicates a remaining fuel amount in the form of a numerical value that is one of 1 to 5 which represent five levels. The user can recognize possible reduction of the voltage of the rechargeable battery 30 by seeing the battery icon 42 and charge the rechargeable battery 30 by connecting the mobile phone 1 to the AC adapter. Furthermore, the user can recognize a possible fuel shortage by seeing the fuel icon 43 and replenish fuel by himself or herself.

When sufficient fuel exists (S105: yes), at step S109 the fuel cell control module 31 determines whether the air opening 17b is uncovered. This determination is made because when the air opening 17b of the mobile phone 1 is covered, the cell unit 32 cannot take in a sufficient amount of oxygen and hence cannot generate power. The fuel cell control module 31 determines whether the air opening 17b is covered by acquiring information indicating a covered/uncovered status of the air opening 17b from the covered/uncovered detecting module 35.

If the air opening 17b is covered (S109: no), at step S111 the main control module 20 urges the user to uncover the air opening 17b. A preferable way to do this is to display on the display screen 40 of the display 13, a display section 44 containing a sentence for urging the user to uncover the air opening 17b such as “The air opening is covered!” (see FIG. 7B).

If the air opening 17b is uncover (S109: yes), at step S113 the fuel cell control module 31 determines whether the outlet 17c is uncover. This determination is made because when the outlet 17c of the mobile phone 1 is covered, moisture etc. produced by power generation cannot be discharged and the cell unit 32 cannot generate power. The fuel cell control module 31 determines whether the outlet 17c is uncover by acquiring information indicating a covered/uncovered of the outlet 17c from the covered/uncovered detecting module 35.

If the outlet 17c is covered (S113: no), at step S115 the main control module 20 urges the user to uncover the outlet 17c. A preferable way to do this is to display, on the display screen 40 of the display 13, a display section 44 containing a sentence for urging the user to uncover the outlet 17c such as “The outlet is covered!” (see FIG. 7C).

The outlet 17c being uncovered (S113: yes) means that the cell unit 32 is not in operation though the remaining battery capacity is low. Since the reason for this situation is unknown, at step S117 the main control module 20 controls the display 13 to display a message to the effect that the fuel cell is inoperative. For example, as shown in FIG. 7D, the main control module 20 controls the display screen 40 of the display 13 to display a display section 44 containing such a sentence as “The fuel cell is inoperative!”

After performance of one of the display steps S107, S111, S115, and S117, the process returns to step S101 to cause the fuel cell control module 31 to again determine whether power generation is being performed. The fuel cell control module 31 monitors whether power generation is being performed properly in the mobile phone 1 by repeating steps S101-S117.

In the mobile phone 1, the voltage of the rechargeable battery 30 and the power generation status of the cell unit 32 are constantly monitored in the above-described manner. If the cell unit 32 is not generating power though the voltage of the rechargeable battery 30 is low, the cause of that situation is specified and an alarm is raised to the user to urge him or her to take a measure that is suitable for the cause such as replenishment of fuel, uncovering of the air opening 17b, uncovering of the outlet 17c, or the like. This allows the user to recognize the reason why power generation is not being performed and to take a measure that is suitable for the reason when the cell unit 32 is not generating power though the voltage of the rechargeable battery 30 is low.

Steps S101-S115 may be replaced by simpler steps. An example method is as follows. In the mobile phone 1, the rechargeable battery 30 generates power constantly irrespective of the voltage of the rechargeable battery 30 and the fuel cell control module 31 constantly checks whether power generation is being performed. When power generation is not being performed or sufficient fuel does not exist, the fuel cell control module 31 alarms the user by controlling the speaker 14 to output an alarm sound or controlling the display 13 to display a message for urging the user to replenish fuel.

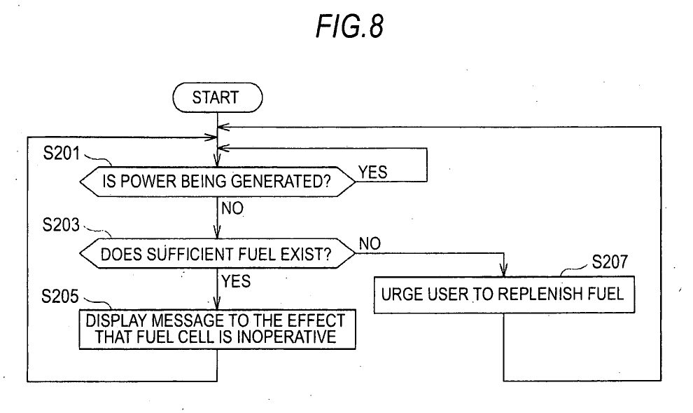

This method makes it possible to easily check the operation status of the cell unit 32 and alarm the user merely by determining whether sufficient fuel exists when, for example, the mobile phone 1 is not equipped with sensors for detecting whether the air opening 17b and the outlet 17c are uncovered or it is not necessary to generate power frequently. An alarm process of this method will be described below with reference to a flowchart of FIG. 8.

First, at step S201, the fuel cell control module 31 determines whether power generation is being performed. For example, the fuel cell control module 31 makes this determination by detecting the output voltage of the cell unit 32 or heat generation. When power generation is being performed (S201: yes), the process returns to step S201 to cause the fuel cell control module 31 to again determine whether power generation is being performed.

If power generation is not being performed (S201: no), at step S203 the fuel cell control module 31 determines whether sufficient fuel exists. For example, the fuel cell control module 31 makes this determination by calculating a remaining fuel amount based on a fuel weight.

If sufficient fuel does not exist (S203: no), at step S205 the main control module 20 urges the user to replenish fuel. A preferable way to do this is to display on the display screen 40 of the display 13 a display section 44 containing a sentence for urging the user to replenish fuel such as “Replenish fuel” (see FIG. 7A).

When power generation is not being performed though sufficient fuel exists (S203: yes), the cell unit 32 is inoperative for some reason. Since the reason is not specified, at step S207 the main control module 20 controls the display 13 to display a message that the fuel cell is inoperative. For example, as shown in FIG. 7D, the main control module 20 controls the display 13 to display a display section 44 containing such a sentence as “The fuel cell is inoperative!” on the display screen 40.

After the display processing of step S205 or S207, the process returns to step S201 to cause the fuel cell control module 31 to again determine whether power generation is being performed. The fuel cell control module 31 monitors whether power generation is being performed properly by repeating steps S201-S207.

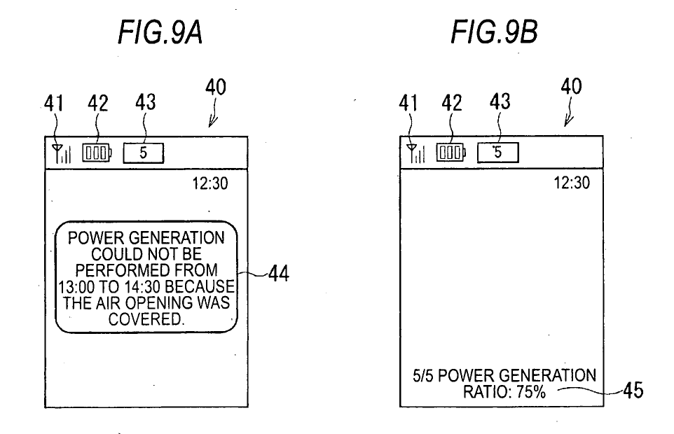

When power generation is not being performed in the mobile phone 1, such information as which opening is covered is not very important to the user. Therefore, it is also appropriate to merely display a display section 44 containing a sentence indicating the fact that power generation is not performed, as well as a period of time when power generation is not performed. FIG. 9A shows an example that a display section 44 containing a sentence “Power generation could not be performed from 13:00 to 14:00 because the air opening was covered” is displayed. Alternatively, as shown in FIG. 9B, a display 45 of characters indicating a power generation time ratio of the day such as “5/5 Power generation ratio: 75%” may be shown on the display screen 40. For example, the power generation time ratio is a ratio of a power generation time of the day to 24 hours.

The method for detecting a remaining fuel amount, the method for detecting whether the air opening 17b or the outlet 17c is covered, and the method for detecting whether power is being generated are not limited to the above-described methods and may be arbitrary methods. For example, as for the detection of a remaining fuel amount, it is sufficient to determine whether a fuel shortage is the cause of the incapability of generating power and it is not necessary to recognize a correct remaining fuel amount. Therefore, a remaining fuel amount may be detected by a method that is different from the ordinary method. If there is another condition that should be satisfied for power generation (e.g., ambient temperature), this may be added to reasons that should be considered when power cannot be generated.

The alarming methods are not limited to the above-described ones either. For example, another method of alarming for an insufficient remaining capacity of the rechargeable battery 30 may be employed in which an alarm is raised at a low frequency when the remaining battery capacity is relatively high and at a high frequency when it is low. The display methods of alarming may also be arbitrary methods.

As described above, in the mobile phone 1, if the fuel cell is not generating power, the reason is specified and the user is alarmed to urge him or her to take a measure that is suitable for the cause such as fuel replenishment. In addition, a period of time when power generation was not performed, a power generation time ratio of the day, or like information is displayed to the user.

In the first embodiment, the mobile phone 1 is equipped with the rechargeable battery 30 and the fuel cell for charging the rechargeable battery 30 and the power generation status of the fuel cell is monitored. The rechargeable battery 30 can be charged efficiently by constantly giving proper information to the user when power generation is not being performed.

### Second Embodiment

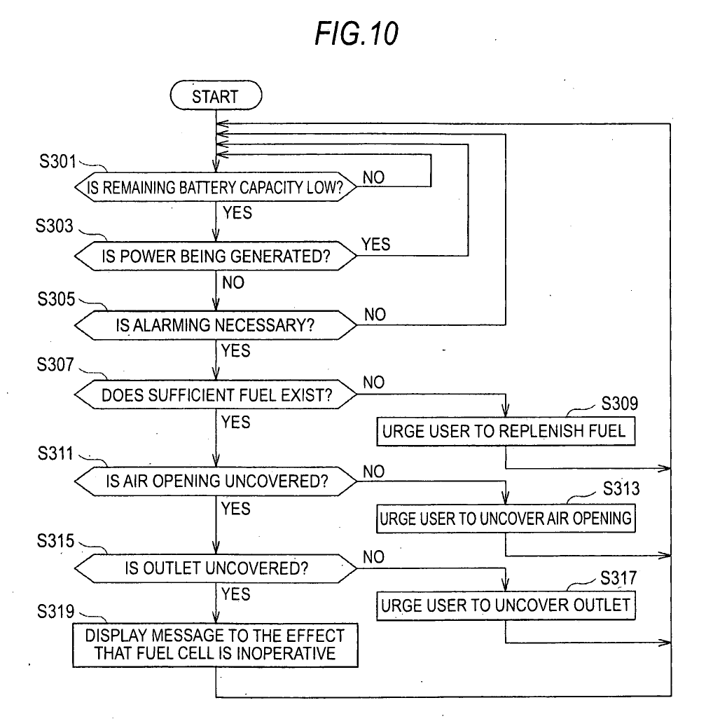

A mobile phone according to a second embodiment of the invention will be described below with reference to FIG. 10. In the following, redundant descriptions will be avoided by giving the same symbol to each component, module, or the like having the same one in the first embodiment. The configuration of the mobile phone 1 according to the second embodiment is the same as that of the mobile phone according to the first embodiment (see FIGS. 1 and 2).

Furthermore, like the mobile phone 1 according to the first embodiment, the mobile phone 1 according to the second embodiment includes the main control module 20, the power circuit module 21, the manipulation input control module 22, the display control module 23, the audio processing module 24, the communication control module 25, the memory 26, and the GPS receiving module 27. They are connected to each other via the bus so as to be able to communicate with each other (see FIG. 3).

In the mobile phone 1 according to the second embodiment, a behavioral pattern of the user is stored in advance. When the rechargeable battery 30 is not being charged by power generation of the fuel cell, the probability that the mobile phone 1 will be rendered unusable is determined from the behavioral pattern of the user. When the probability that the mobile phone will be rendered unusable is low, the user is not alarmed even when power generation is not being performed because of covering the air opening 17b or the outlet 17c. The user is alarmed if the probability that the mobile phone 1 will be rendered unusable is high and power generation is necessary.

For example, when the mobile phone 1 detects voltage reduction of the rechargeable battery 30, and position information sequence including current position information that was acquired from a GPS system or the like by the GPS receiving module 27 regularly or every time an event occurs are compared with a usual (daily) behavioral pattern of the user. When the position information sequence does not match the usual behavioral pattern, the mobile phone 1 determines that an alarm is to be raised because what will happen next cannot be estimated. When it is determined that the position information sequence matches the usual behavioral pattern and that much battery energy will very likely be consumed soon (e.g., a period of time in which frequent communication is expected), then the mobile phone 1 determines that an alarm is to be raised. When the usual behavioral pattern suggests that much battery energy will not be consumed soon or that the opening will be uncovered soon, the mobile phone 1 determines that it is not necessary to raise an alarm.

For example, the usual behavioral pattern includes information of position information and voltage values of the rechargeable battery 30 for individual periods of time of each day, and a graph showing a relationship between the average voltage of the rechargeable battery 30 and corresponding time. For example, it can be determined that it is not necessary to sound an alarm to urge the user to take action for power generation when the user is currently moving within an area from his or her home to the company, the school or the like and power generation is not being performed because the mobile phone 1 is put in a bag or a pocket, but the usual behavioral pattern shows that a power-generation-possible state will be restored when the user arrives at the company, the school or the like. In such a case, sounding an alarm unnecessarily may annoy nearby people or make the user feel uncomfortable. When the user is writing a mail with the mobile phone, it is not necessary to sound an alarm because it is determined that the air opening 17b or the outlet 17c will not be covered for a long time.

The kind of information that is a base of a behavioral pattern is not limited to GPS information. For example, in the case of a mobile phone with an ID card, information relating to use of the ID card (e.g., company entering/leaving management information, a name of a store where payment was made, and use-of-transportation facilities information) can be used. Other examples are information indicative of a life pattern information such as wake-up setting time in the mobile phone 1 and an area code that is received from a base station.

The procedure of an alarm process of the mobile phone 1 in which a behavioral pattern of the user is taken into consideration will be described below with reference to a flowchart of FIG. 10. The mobile phone 1 constantly performs this alarm process while it is activated irrespective of whether it is being used by the user for a communication or the like or it is in a standby state.

First, at step S301, the fuel cell control module 31 determines whether the remaining capacity (voltage) of the rechargeable battery 30 is low. More specifically, the fuel cell control module 31 calculates a voltage of the rechargeable battery 30 and determines that the remaining battery capacity is low if the calculated battery voltage is lower than the first threshold value (the charging-unnecessary voltage shown in FIG. 4) (S301: yes). If the remaining battery capacity is not low (S301: no), the fuel cell control module 31 stands by because it is not necessary to generate power.

If the remaining battery capacity is low (S301: yes), at step S303 the fuel cell control module 31 determines whether power generation is being performed by the cell unit 32 by using fuel. More specifically, the fuel cell control module 31 checks whether power generation is being performed by, for example, detecting an output voltage of the cell unit 32 or heat generation. If power generation is being performed (S303: yes), the process returns to step S301 to cause the fuel cell control module 31 to again determine whether the remaining battery capacity is low because it is not necessary to alarm the user.

If the remaining battery capacity is low and power generation is not being performed (S303: no), since in this case power generation should be being performed, at step S305 the fuel cell control module 31 determines whether to raise, to the user, an alarm to the effect that power generation is not being performed. More specifically, the fuel cell control module 31 compares the position information sequence including current position information that was acquired from a GPS system or the like by the GPS receiving module 27 regularly or every time an event occurs with the usual behavioral pattern of the user. When the position information sequence does not match the usual behavioral pattern, the fuel cell control module 31 determines that an alarm is to be raised because what will happen next cannot be estimated. When it is determined that the position information sequence matches the usual behavioral pattern and much battery energy will very likely be consumed soon (e.g., a period of time in which frequent communication is expected), then the fuel cell control module 31 determines that an alarm is to be raised. When the usual behavioral pattern suggests that much battery energy will not be consumed soon and the air opening 17b or the outlet 17c will be uncovered soon, the fuel cell control module 31 determines that it is not necessary to raise an alarm.

When it is determined that alarming is not necessary (S305: no), the process returns to step S301 to cause the fuel cell control module 31 to again determine whether the remaining battery capacity is low. When it is determined that alarming is necessary (S305: yes), to specify the reason why power generation is not being performed, first the fuel cell control module 31 determines at step S307 whether sufficient fuel exists. The fuel cell control module 31 makes this determination by calculating a remaining fuel amount based on a fuel weight, for example.

When sufficient fuel does not exist (S307: no), at step S309 the main control module 20 urges the user to replenish fuel. A preferable way to do this is to display, on the display screen 40 of the display 13, a display section 44 containing a sentence for urging the user to replenish fuel such as “Replenish fuel” (see FIG. 7A).

When sufficient fuel exists (S307: yes), at step S311 the fuel cell control module 31 determines whether the air opening 17b is covered. This determination is made because when the air opening 17b of the mobile phone is covered the cell unit 32 cannot take in a sufficient amount of oxygen and hence cannot generate power. The fuel cell control module 31 determines whether the air opening 17b is covered by acquiring information indicating a covered/uncovered status of the air opening 17b from the covered/uncovered detecting module 35.

When the air opening 17b is covered (S311: no), at step S313 the main control module 20 urges the user to uncover the air opening 17b. A preferable way to do this is to display, on the display screen 40 of the display 13, a display section 44 containing a sentence for urging the user to uncover the air opening 17b such as “The air opening is covered!” (see FIG. 7(B)).

When the air opening 17b is uncovered (S311: yes), at step S315 the fuel cell control module 31 determines whether the outlet 17c is uncovered. This determination is made because When the outlet 17c of the mobile phone is covered, moisture etc. produced by power generation cannot be discharged and the cell unit 32 cannot generate power. The fuel cell control module 31 determines whether the outlet 17c is covered by acquiring information indicating a covered/uncovered status of the outlet 17c from the covered/uncovered detecting module 35.

When the outlet 17c is covered (S315: no), at step S317 the main control module 20 urges the user to uncover the outlet 17c. A preferable way to do this is to display, on the display screen 40 of the display 13, a display section 44 containing a sentence for urging the user to uncover the outlet 17c such as “The outlet is covered!” (see FIG. 7C).

The outlet 17c being uncovered (S315: yes) means that the cell unit 32 is not in operation though the remaining battery capacity is low. Since the reason for this situation is not specified, at step S319 the main control module 20 controls the display 13 to display a message that the fuel cell is inoperative. For example, as shown in FIG. 7D, the main control module 20 controls the display 13 to display a display section 44 containing such a sentence as “The fuel cell is inoperative!” on the display screen 40.

After one of the display steps S309, S313, S317, and S319, the process returns to step S301 to cause the fuel cell control module 31 to again determine whether power generation is being performed. The fuel cell control module 31 monitors whether power generation is being performed properly in the mobile phone 1 by repeating steps S301-S319.

In the mobile phone 1, the voltage of the rechargeable battery 30 and the power generation status of the cell unit 32 are monitored in the above-described manner. When the cell unit 32 is not generating power though the voltage of the rechargeable battery 30 is low, whether alarming is necessary is determined based on the usual behavioral pattern of the user. Only if alarming is necessary, the cause of that situation is specified and an alarm is raised to the user to urge him or her to take a measure that is suitable for the cause such as replenishment of fuel, uncovering the air opening 17b, uncovering the outlet 17c, or the like. This allows the user to recognize the reason why power generation is not being performed and to take a measure that is suitable for the reason if the cell unit 32 is not generating power though the voltage of the rechargeable battery 30 is low (i.e., the rechargeable battery 30 should be charged).

In the second embodiment, the mobile phone 1 is equipped with the rechargeable battery 30 and the fuel cell for charging the rechargeable battery 30 and the power generation status of the fuel cell is monitored. The rechargeable battery 30 can be charged efficiently by constantly giving proper information to the user when power generation is not being performed.

Although the above description of the invention is directed to the mobile phone, the application range of the invention is not limited to it. The invention can be applied to any mobile apparatuses having a fuel cell, such as personal handyphone system (PHS), personal digital assistants (PDAs), digital cameras, video cameras, portable audio apparatuses, and portable video apparatuses.

What is claimed is:

1. A mobile apparatus comprising:
a rechargeable battery;
a fuel cell configured to charge the rechargeable battery;
a first determining module configured to determine whether the fuel cell is generating power;
a second determining module configured to determine whether a power generation condition of the fuel cell is satisfied when the first determining module determines that the fuel cell is not generating power; and
a notifying module configured to notify a user that the fuel cell is not generating power when the second determining module determines that the power generation condition is satisfied.

2. The mobile apparatus of claim 1, further comprising a third determining module configured to determine whether a voltage of the rechargeable battery is lower than a threshold value, wherein
the first determining module is configured to determine whether the fuel cell is generating power when the third determining module determines that the voltage of the rechargeable battery is lower than the threshold value.

3. The mobile apparatus of claim 1, further comprising:
a body having an opening configured to supply air therethrough to the fuel cell; and
a fourth determining module configured to determine whether the opening is covered when the first determining module determines that the fuel cell is not generating power, wherein
the notifying module is configured to urge the user to uncover the opening when the fourth determining module determines that the opening is covered.

4. The mobile apparatus of claim 1, further comprising:
a body having an outlet configured to discharge moisture therethrough, the moisture generated by generating power at the fuel cell; and
a fifth determining module configured to determine whether the outlet is covered when the first determining module determines that the fuel cell is not generating power, wherein
the notifying module is configured to urge the user to uncover the outlet when the fifth determining module determines that the outlet is covered.

5. The mobile apparatus of claim 1, further comprising:
a memory configured to store a period of time when the first determining module determined that the fuel cell was not generating power; and
a display module configured to display the period of time.

6. The mobile apparatus of claim 1, further comprising:
a memory configured to store information associated with a behavioral pattern of the user and corresponding voltages of the rechargeable battery;
a sixth determining module configured to determine whether to notify the user based on a current voltage of the rechargeable battery and the information when the first determining module determines that the fuel cell is not generating power, wherein
the notifying module is configured to urge the user to replenish fuel when the sixth determining module determines that it is necessary to alarm the user.

7. A mobile apparatus comprising:
a rechargeable battery;
a fuel cell configured to charge the rechargeable battery;
a first determining module configured to determine whether the fuel cell is generating power;
a second determining module configured to determine whether sufficient fuel for the fuel cell exists when the first determining module determines that the fuel cell is not generating power; and
a notifying module configured to notify a user that the fuel cell is not generating power when the second determining module determines that the sufficient fuel exists.

8. The mobile apparatus of claim 7, further comprising a third determining module configured to determine whether a voltage of the rechargeable battery is lower than a threshold value, wherein
the first determining module is configured to determine whether the fuel cell is generating power when the third determining module determines that the voltage of the rechargeable battery is lower than the threshold value.

9. The mobile apparatus of claim 7, further comprising:
a body having an opening configured to supply air therethrough to the fuel cell; and
a fourth determining module configured to determine whether the opening is covered when the first determining module determines that the fuel cell is not generating power, wherein
the notifying module is configured to urge the user to uncover the opening when the fourth determining module determines that the opening is covered.

10. The mobile apparatus of claim 7, further comprising:
a body having an outlet configured to discharge moisture therethrough, the moisture generated by generating power at the fuel cell; and
a fifth determining module configured to determine whether the outlet is covered when the first determining module determines that the fuel cell is not generating power, wherein
the notifying module is configured to urge the user to uncover the outlet when the fifth determining module determines that the outlet is covered.

11. The mobile apparatus of claim 7, further comprising:
a memory configured to store a period of time when the first determining module determined that the fuel cell was not generating power; and
a display module configured to display the period of time.

12. The mobile apparatus of claim 7, further comprising:
a memory configured to store information associated with a behavioral pattern of the user and corresponding voltages of the rechargeable battery;
a sixth determining module configured to determine whether to notify the user based on a current voltage of the rechargeable battery and the information when the first determining module determines that the fuel cell is not generating power, wherein
the notifying module is configured to urge the user to replenish fuel when the sixth determining module determines that it is necessary to alarm the user.

13. A mobile phone comprising:
a rechargeable battery;
a fuel cell configured to charge the rechargeable battery;
a communication control module configured to receive and monitor radio waves;
a first determining module configured to determine whether the fuel cell is generating power;
a second determining module configured to determine whether a power generation condition of the fuel cell is satisfied when the first determining module determines that the fuel cell is not generating power; and
a notifying module configured to notify a user that the fuel cell is not generating power when the second determining module determines that the power generation condition is satisfied.

14. The mobile phone of claim 13, further comprising a third determining module configured to determine whether a voltage of the rechargeable battery is lower than a threshold value, wherein
the first determining module is configured to determine whether the fuel cell is generating power when the third determining module determines that the voltage of the rechargeable battery is lower than the threshold value.

15. The mobile phone of claim 13, further comprising:
a body having an opening configured to supply air therethrough to the fuel cell; and
a fourth determining module configured to determine whether the opening is covered when the first determining module determines that the fuel cell is not generating power, wherein
the notifying module is configured to urge the user to uncover the opening when the fourth determining module determines that the opening is covered.

16. The mobile phone of claim 13, further comprising:
a body having an outlet configured to discharge moisture therethrough, the moisture generated by generating power at the fuel cell; and
a fifth determining module configured to determine whether the outlet is covered when the first determining module determines that the fuel cell is not generating power, wherein
the notifying module is configured to urge the user to uncover the outlet when the fifth determining module determines that the outlet is covered.

17. The mobile phone of claim 13, further comprising:
a memory configured to store a period of time when the first determining module determined that the fuel cell was not generating power; and
a display module configured to display the period of time.

18. The mobile phone of claim 13, further comprising:
a memory configured to store information associated with a behavioral pattern of the user and corresponding voltages of the rechargeable battery;
a sixth determining module configured to determine whether to notify the user based on a current voltage of the rechargeable battery and the information when the first determining module determines that the fuel cell is not generating power, wherein
the notifying module is configured to urge the user to replenish fuel when the sixth determining module determines that it is necessary to alarm the user.

19. The mobile apparatus of claim 1, wherein the notifying module is configured to notify the user by displaying.

20. The mobile apparatus of claim 1, wherein the notifying module is configured to notify the user by sounding.
